(19) United States
(12) Patent Application Publication
(10) Pub. No.: US 2003/0001457 A1
(43) Pub. Date: Jan. 2, 2003

(54) Flat panel display and method of manufacture

(75) Inventors: Weijie Wang, Singapore (SG); Minghui Hong, Singapore (SG); Chengwu An, Singapore (SG); Yong Feng Lu, Singapore (SG)

Correspondence Address: HOGAN & HARTSON L.L.P., 500 S. GRAND AVENUE, SUITE 1900, LOS ANGELES, CA, 90071-2611, US

(73) Assignee: DATA STORAGE INSTITUTE

(21) Appl. No.: 09/957,636

(22) Filed: Sep. 19, 2001

(30) Foreign Application Priority Data
Jun. 29, 2001 (SG) 200103998-1

(51) Int. Cl. H02N 2/00

(52) U.S. Cl. 310/328

(57) ABSTRACT

In a flat panel display, a laser spacer array is created on the transparent substrate 10′ to maintain the two substrates at a pre-determined spacing in the finished panel. The spacers 20 are distributed between the two substrates, which are sealed using sealant 18 resulting in a cell gap with pre-determined spacing distance.

The gap between the two sealed substrates 10 and 10′ forms a cell for a liquid crystal 22. The gap of the cell should be uniform for good liquid crystal performance. The laser-induced spacers 20′ have a pre-determined profile with uniform height, diameter and distribution. The spacer characteristics can be flexibly and precisely controlled.

### FIELD OF INVENTION

The invention relates, particularly, but not exclusively, to a shear mode piezoelectric actuator for driving the slider and head for fine positioning the read/write head over the rotatable disc media.

### BACKGROUND OF THE INVENTION

The track density of hard disk drives (HDDs) has kept increasing drastically these years. The tract density per inch (TPI) will be expected to be 100,000 in the near future. Accordingly, the track width (TW) will be decreased to less than ¼ of a micrometer. Thus, extremely high precision is required to position the read/write (R/W) head on such narrow tracks. Currently, the head positioning is accomplished by a servo system, which is composed of a voice coil motor (VCM) driven actuator arm and a head gimbal assembly (HGA). Due to the nonlinear friction in the pivot bearing and the structural resonant modes of the arm and the suspension, the bandwidth of the single stage servo loop is limited. This restricts the ability of the servo system to reject the various vibrations in the hard disk drive caused by windage, disk fluttering, power amplifier, and so on.

A widely accepted solution to support higher bandwidth servo system is a dual-stage servo control system which uses the VCM in combination with a high bandwidth secondary actuators. The microactuators can be of non-collected designs such as actuated suspensions, or collocated designs such as actuated sliders and actuated head. Collocated microactuator design generally has higher secondary bandwidth and better controllability.

In the actuated suspension design, the microactuators are placed on the suspension and piezoelectrically or electromagnetically driven to swing the head gimbal assembly. These actuators can be fabricated using conventional machining technology. However, the performance of this kind of actuators is influenced by the mechanical resonance of the suspension and gimbal.

For the actuated slider design, the microactuators are micromachined, placed between the suspension and the slider and electrostatically, electromagnetically or piezoelectrically driven to move the head slider. The performance of this kind microactuators is no longer influenced by the mechanical resonance of the head suspension. However, the microactuators are nearly the same size as the slider, they will affect the suspension preload and the flying characteristics.

The third kind of microactuators is micromachined on the head slider and electrostatically driven to move the R/W head element. The actuated head design is clearly attractive as the mass of the head to be driven is tiny. The drawback is that it adds considerable complexity to the fabrication process.

From the viewpoint of the actuation mechanism, there are three main categories of secondary microactuators: piezoelectric, electromagnetic and electrostatic. The excellent features which a piezoelectric microactuator possesses such as small in size, simple in structure, high in frequency response and yet capable of producing sufficient displacement with reasonable low drive voltage make it one of the best option as the secondary actuator.

There is a need in the art for a secondary microactuator design that provides extremely high resolution of the R/W head positioning while the second actuator can be fabricated efficiently and inexpensively using proven technologies.

### SUMMARY OF THE INVENTION

The present invention intends to provide shear mode piezoelectric microactuator based slider and head microactuation devices, which has high displacement sensitivity, low profile, simple structure and minimal effects on flying characteristics, and which are suitable for use as a collocated secondary stage servo system for high TPI hard disk drives.

A object of the present invention is to provide a shear mode piezoelectric microactuator, which is placed on the back side of the slider to move the slider in horizontal plane for precisely positioning the R/W head on high density disk tracks. The shear mode piezoelectric actuator whose poling direction is perpendicular to that of the applied electric field has higher displacement sensitivity (d15 is generally larger than both d33 and d31) and its displacement constant is independent of the dimensions of the piezoelectric element. Therefore, shear mode piezoelectric actuator is suitable for very thin structures without losing its displacement sensitivity. The only shear mode PZT actuator for HDD servo is the shear mode PZT driven suspension proposed by Fujitsu (See Koganezawa, S.; Uematsu, Y.; Yamada, T.; Nakano, H.; Inoue, J.; Suzuki, T., Dual-stage actautor system for magnetic disk drives using a shear mode piezoelectric microactuator Magnetics, IEEE Transactions on, Volume: 35 Issue: 2 Part: 1, March, 1999 Page(s): 988-992).

A final object of the present invention is to provide the relevant head gimbal assemblies for supporting the relevant slider actuation devices states above.

The placement of the piezoelectric actuator on the side of slider as well as the actuation mechanisms produces several excellent features of the present invention. They include high displacement sensitivity, minimal influence on suspension preload and flying characteristics due to low profile actuator and no change of disk spacing, pure translation movement caused by piezoelectric actuation only in horizontal plane, same position for load point and actuator setting position, easy integration into the existing head gimbal assembly, and simple structure and proven technology for fabrication. With these advantages and features, the said actuated slider can be incorporated into a hard disk servo system to position the R/W head to track runout quickly and accurately.

Other objects, as well as the structures and features of the present invention to achieve those objects, will be understood by considering the following detailed description of the preferred embodiment, presented in the accompanying drawings.

### BRIEF DESCRIPTION OF THE DRAWINGS

FIG. 1 is a top view of a hard disk drives;

FIG. 2 is a perspective view of a conventional swage-mounted head suspension assembly for hard disk drives;

FIG. 3A is a perspective view of an actuated slider design using a shear mode piezoelectric microactuator on the backend of the slider. The actuated slider is attached to the head gimbal assembly via a supporting frame.

FIG. 3B is a perspective view of the same actuated slider design as in FIG. 3A except that modified flexure is used to directly hold the actuated slider.

FIG. 3C is the top view of the actuated slider design illustrating the actuation mechanism.

FIG. 3D is the top view of a shear mode piezoelectric actuator.

FIG. 4A is a perspective view of an actuated slider design using two shear mode piezoelectric microactuators on each side of the slider.

FIG. 4B is the top view of the actuated slider design shown in FIG. 4A illustrating the actuation mechanism.

FIG. 4C is the top view of another modified actuated slider design.

### DETAILED DESCRIPTION OF PREFERRED EMBODIMENTS

Hereinafter, basic structures and preferred embodiments of the present invention will be described with reference to the drawings.

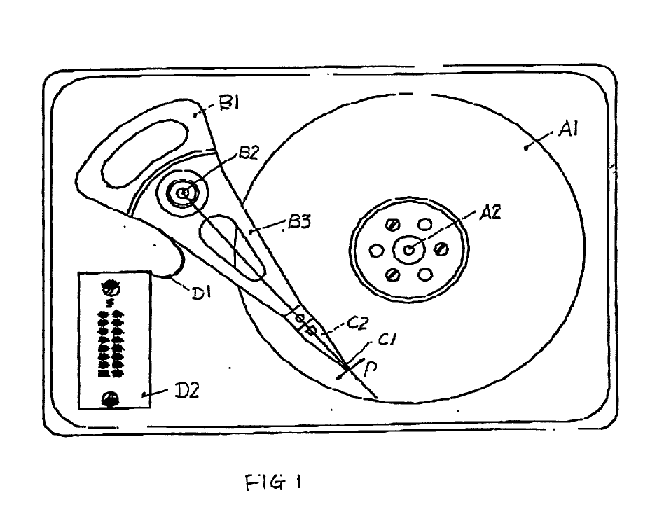

FIG. 1 illustrates an embodiment of this aspect of the present invention. Shown in FIG. 1 is a top view of a hard disk drive with high bandwidth actuated slider. Designated by reference A1 is a plurality of data disks, only one of them can be seen in plan view, and A2 is a spindle motor for rotating the disks all together at a high speed. An array of vertically aligned piezoelectrically actuated head sliders of the present invention, one of which is designated by reference C1, is attached through a plurality of compound suspensions C2 to a plurality of supporting arms B3. The preferred embodiments of the actuated slider assemblies will be discussed below. An electromagnetic voice coil motor (VCM) B1 is used as the primary stage rotary actuator to move all the head slider around a pivot bearing B2 in a long stroke to any desired one of a plurality of tracks on the surfaces of the disk A1 along an actuated path P for track seeking. D1 is a flexible cable and D2 is a connector as an interface to a computer.

Although the actuated slider system in this embodiment is illustrated by an example of hard disk drive, it is also applicable to optical disk or magneto-optical storage devices for obtaining high compact feature.

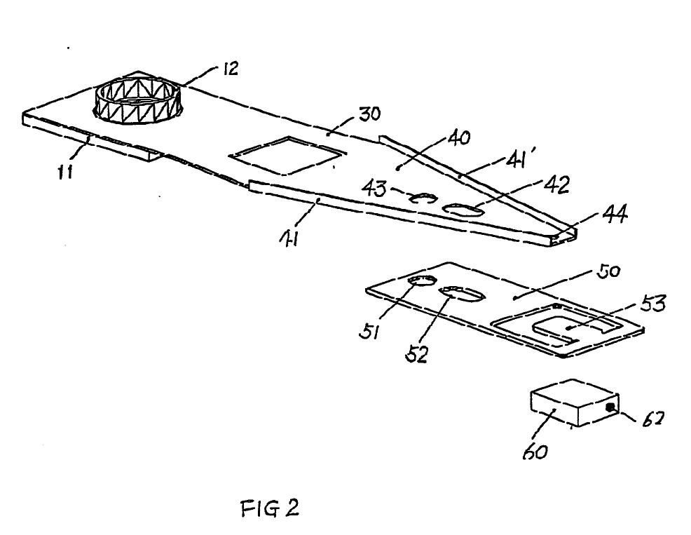

FIG. 2 shows a conventional swage-mounted suspension assembly. It is made up of four main parts: a baseplate 11 with swage boss 12, a spring beam 30, a rigid load beam 40, a flexure 50 and slider 60. The suspension supports a head slider and provides the gramload necessary for the head to fly at the desired height about a disk. The suspension is attached to a supporting arm (designated by reference B3 in FIG. 1) by swaging the boss 12 on the baseplate to a hole on the arm B3. The suspension also incorporates flanges 41 and 41′ as stiffening ribs. The compliance of the suspension is mainly attributed to the load beam where no flange exists. There is one flexure 50 between the distal end of the suspension and the slider/head assembly 60, which has high compliance in the pitch, roll and vertical directions and high stiffness in the yaw and in-plane directions. The slider 60 flies over the surface of the rotating disk A1 due to aerodynamic force.

In the present invention, the low profile piezoelectric actuators are placed on the side or back end of the slider 60 so that the disk spacing remains no changed and the influence on flying characteristics is minimized. The performance of actuated slider will not affected by the resonance of the suspension and actuator arm. Meanwhile, the piezoelectric actuation on the sides of the slider will only cause pure in-plane motion of the slider. The present invention has several excellent features. They include high displacement sensitivity, minimal influence on suspension preload and flying characteristics due to low profile actuator and no change of disk spacing, pure translation movement caused by piezoelectric actuation only in horizontal plane, same position for load point and actuator setting position, easy integration into the existing head gimbal assembly, simple structure and proven technology for fabrication.

As stated above, shear mode piezoelectric actuator has some excellent features, such as larger piezoelectric constant and its micro-displacement independent of the dimensions of the actuator. Therefore, shear mode actuator is suitable for microstructures. Embodiments using shear mode microactuator for slider actuation will be explained below.

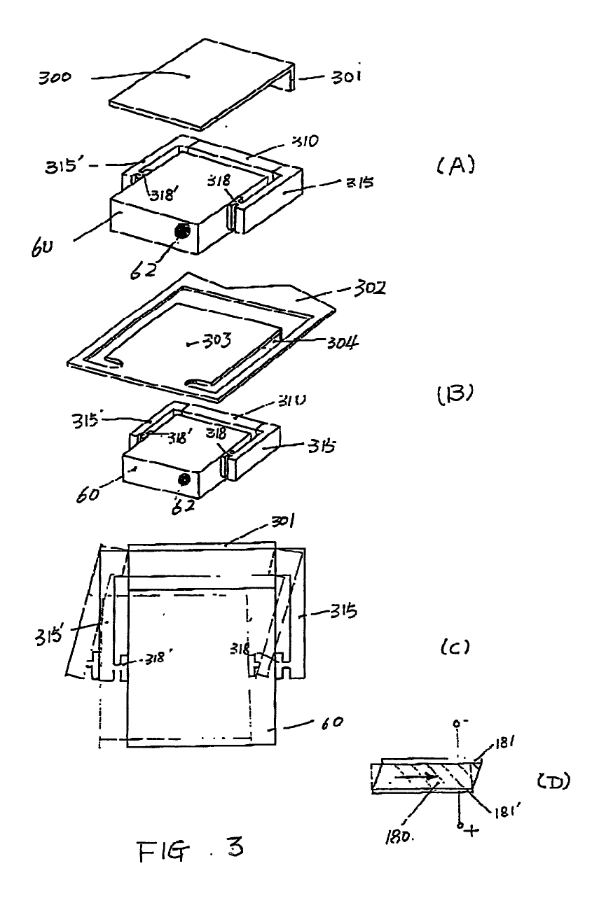

FIG. 3 shows an embodiment of the actuated slider using shear mode piezoelectric element. A shear mode piezoelectric microactuator 310 is placed at the back side of the slider 60. A pair of arm 315 and 315′ is attached on both side of the actuator 310 to magnify the shear displacement. There are two flexible pad 318 and 318′ at the ends of the 315 and 315′. The end face of flexible pads 318 and 318′ are bonded to slider 60. The flexible pads, which are rigid enough in vertical direction, can swing around its hinge in horizontal plane so as to keep the slider in almost translation movement during piezoelectric actuation. The actuated slider assembly comprised of 310, 315, 315′ 318, 318′ is attached to a frame 300 with a vertical tab 310 at its back end. The frame 300 is then attached to 53 of the flexure 50.

FIG. 3D shows the operational principle of shear mode piezeoelectric actuator. A shear element 180 is horizontally polarized. When voltage is applied on electrode 181 and 181′ the piezeoelectric element shears as shown by solid line. FIG. 6C illustrates the working principle of the actuated slider assembly. When the piezoelectric microactuator 310 shears, the arm 310 and 315′ magnifies the shear displacement and drives the slider 60 through flexible pad 318 and 318′, which self-adjust the position of the slider so that it moves in translation. The length of the arm 315 and 315′ can be changed to alter the magnifying ratio so as to obtain the required displacement of the slider.

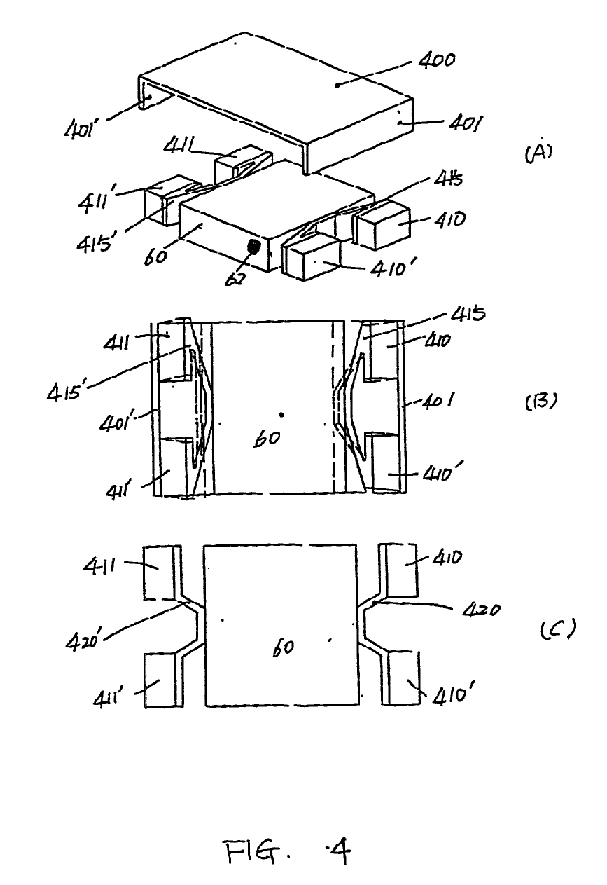

FIG. 4 shows another embodiment of the present invention using the shear mode piezoelectric microactuator. In FIG. 4A, four shear mode actuator 410, 410′, 411, and 411′ are placed on two side of the slider. A displacement magnifier 415 and 415′ are attached between the shear actuator and the slider. The 415 and 415′ are thin beam structures that can be micro-fabricated. The outer faces of the four shear actuator are attached to tabs 401 and 401′ of the frame 400, which in turn attached to the flexure 50 through 53 shown in FIG. 2.

FIG. 4B shows the operation of the actuated slider assembly. Two piezoelectric elements on the same sides (for example 410 and 410′) shear in the opposite direction, the displacement magnifier 415 then magnifies the shear displacement and pushes or pulls the slider in transverse direction. The shear motions of the four piezoelectric elements on both sides are arranged in such way that one side pushes the slider while the other pulls it. Again, the slider moves transversely in pure translation, and this motion can be used as the servo motion for fine positioning and following the R/W head on the high-density disk tracks. FIG. 4C shows a modification of FIG. 4B. The only difference is that another microstructure 420 and 420′ are used instead of the 415 and 415′ as the displacement magnifier.

Although the above explanations are made by referring single layer shear mode piezoelectric actuator, It is also applicable to multi-layer piezoelectric shear actuators.

The present invention provides a micro-actuation system for fine positioning the R/W head on high-density disk tracks. Micro-actuation system can be manufactured by either traditional machining technologies or advanced microfabrication technologies. For traditional manufacturing, the piezoelectric element, its related microstructure and slider can be fabricated individually and assembled using the available technologies. For advanced microfabrication, piezoelectric element, its related structure and the slider can be fabricated using the similar art to manufacture recording heads for disk drives. The slider, layers of the piezoelectric microactuators as well as the related microstructure could be simultaneously formed on the same substrate. The ease of formation of the microactuators, integrated into the wafer level process, makes the present invention readily for mass production.

The scale-downed piezoelectric microactuators in present inventions can also be used to directly drive the read/write head element by embedding the microactuators into the slider body.

Although the present invention has been described with reference to preferred embodiments. Workers skilled in the art will recognize that changes may be made in form and detail without departing from the spirit and scope of the invention.

1. A piezoelectric microactuation system for secondary fine positioning the read/write head of hard disk drives comprising:
a) Slider body having a top surface face adjacent to the flexure, a air bearing surface confronting the rotating disc having plurality of concentric tracks, a front surface which is normal to both top and bottom surfaces, a back surface opposite the front surface, and two side surfaces which is normal to above four surfaces. A mid-datum plane is defined as a plane which is in parallel and has equal distances to two sides faces.
b) Read/write head at the front surface of the slider body;
c) The piezoelectric microactuator placed on the side surfaces or back surface of the slider body piezoelectrically drive the slider body to displace the read/write head with respect to the tracks in response to control signals applied to the microactuators;
d) Micro-frame or modified flexure to support the microactuator and slider body; and
e) Adhesive pads connecting the microactuator and the slider body.

2. The piezoelectric microactuation system of claim 1, wherein the microactuator comprises:
a) A shear mode piezoelectric element placed in parallel to the back surface of the slider body, the shear elements being polarized along the lengthwise direction and electrical field along thickness direction.
b) A parallelogram mechanism including a shear element in claim 1a, two symmetrical beams (along the mid-datum plane) with two ends rigidly connecting to the shear element and the other ends connecting to slider body through two flexible pads;

3. The piezoelectric microactuation system of claim 1, wherein the microactuator comprises
a) 4 identical shear mode piezoelectric elements, with two elements on each side and being aligned to each other as well as aligned to the front end face of the slider assembly. The two shear elements on each side are symmetrical along the mid-datum plane.
b) Two curved elastic beams symmetrical along the mid-datum plane are attached to the shear elements and the slider body for amplifying the shear displacement.

4. The piezoelectric microactuation system of claim 1, wherein the relevant micro frames with protruding tabs that are normal to the top and bottom surface of the slider body are applied to hold the microactuators in claim 2, and 3.

5. The piezoelectric microactuation system of claim 1, wherein the relevant flexure with protruding tabs that are normal to the top and bottom surface of the slider body are applied to hold the microactuators in claim 2 and 3.
